(19) United States
(12) Patent Application Publication
(10) Pub. No.: US 2026/0031725 A1
(43) Pub. Date: Jan. 29, 2026

(54) POWER SUPPLY WITH POWER FACTOR CORRECTION

(71) Applicant: Flex Ltd., Singapore (SG)

(72) Inventors: Xiaodong Liu, SHENZHEN (CN); Hua Min Xu, Shenzhen (CN); Weian Chen, Shenzhen (CN); Hu Tang, Shenzhen (CN); Chongsheng Ma, Shenzhen (CN)

(73) Assignee: Flex Ltd., Singapore (SG)

(21) Appl. No.: 18/805,311

(22) Filed: Aug. 14, 2024

(30) Foreign Application Priority Data
Jul. 26, 2024 (CN) 202411017613.6

(51) Int. Cl. H02M 3/157; H02M 1/00; H02M 1/42

(52) U.S. Cl. CPC H02M 3/157; H02M 1/0009; H02M 1/4208

(57) ABSTRACT

At least one example embodiment is directed to a power supply device. The power supply device includes a power factor correction circuit; a DC-DC converter; and one or more controller circuits configured to: monitor an output current of the DC-DC converter; detect, based on the output current of the DC-DC converter, one of a drop and an increase in the output current; and control the power factor correction circuit in response to the one of the drop and the increase in the output current.

### CROSS REFERENCE TO RELATED APPLICATION

The present application claims the benefit of and priority to Chinese Patent Application No. 202411017613.6 filed Jul. 26, 2024, the entire disclosure of which is hereby incorporated by reference for all that it teaches and for all purposes.

### FIELD

The present disclosure is generally directed to devices, systems, and methods for power supplies, in particular, power supplies that convert alternating current (AC) signals to direct current (DC) signals.

### BACKGROUND

Many modern devices and computing system applications, such as data centers, utilize power supplies that convert an AC input signal, such as from a utility grid, into a DC output signal for supplying power to the device or other load. For example, an AC/DC power supply may provide power from a utility grid to one or more servers.

### BRIEF DESCRIPTION OF THE DRAWINGS

FIG. 1 illustrates a block diagram of a system according to at least one example embodiment;

FIG. 2 illustrates a method according to at least one example embodiment;

FIG. 3 illustrates a block diagram of a system according to at least one example embodiment;

FIG. 4 illustrates a method according to at least one example embodiment; and

FIG. 5 illustrates a block diagram of a computing system according to at least one example embodiment.

### SUMMARY

At least one example embodiment is directed to a power supply device. The power supply device includes a power factor correction circuit; a DC-DC converter; and one or more controller circuits configured to: monitor an output current of the DC-DC converter; detect, based on the output current of the DC-DC converter, one of a drop and an increase in the output current; and control the power factor correction circuit in response to the one of the drop and the increase in the output current.

At least one example embodiment is directed to a power factor correction controller. The power factor correction controller includes one or more circuits to: monitor an output current of a DC-DC converter; detect, based on the output current of the DC-DC converter, one of a drop and an increase in the output current; and control a power factor correction circuit in response to the one of the drop and the increase in the output current.

At least one example embodiment is directed to a method of providing power factor correction for a power supply, the method includes: monitoring an output current of a DC-DC converter; detecting, based on the output current of the DC-DC converter, one of a drop and an increase in the output current; and controlling a power factor correction circuit in response to the one of the drop and the increase in the output current.

### DETAILED DESCRIPTION

Data centers and other computing facilities require significant infrastructure, among which there is a power subsystem. The power subsystem of a modern data center normally includes an AC/DC power supply and an energy storage system. A utility grid provides power to racks of servers through the AC/DC power supply.

In recent years, with innovation rapidly driving up the power demand, global power usage, such as for artificial intelligence (AI) technology has increased to gigawatts. The pattern of power usage of data centers includes high-level transients at large scales. Such high-level transients cause peak power consumption simultaneously, as a result, peak power transients add to large AC inrush current from the utility grid during computationally heavy and communication-heavy phases such as AI operations.

Power supplies may be used to ensure efficient and reliable operation of servers and other critical components within a data center. Such power supplies may convert alternating current (AC) from a power grid or direct current (DC) from a battery bank into DC power as required by the data center components. Such power supplies can be designed to handle high power demands while maintaining robustness against fluctuations and interruptions from the primary power source.

A high load event in the context of a power supply device as described herein may refer to a scenario where the power demand from a connected load abruptly increases to a level that approaches or exceeds the capacity of the power supply. Such a situation may occur in various applications, including data centers, industrial settings, or during the operation of high-performance computing systems.

With conventional power supplies, when a sharp increase in output load occurs, the bulk capacitor voltage drops and an overshoot in the output voltage occurs when the PFC circuit tries to account for both the increase in load and the drop in bulk capacitor voltage.

A droop in the context of power supply as described herein may refer to a temporary reduction in the output voltage which may occur when the load on the power supply suddenly increases. A droop may be observed during high load events where the demand for power abruptly rises, potentially surpassing what the power supply can deliver without some loss in performance.

AC/DC power supplies may include a power factor correction (PFC) circuit with low-speed response (e.g., on the level of hundreds of milliseconds) and a DC-DC converter with a high-speed response (e.g., on the level of microseconds level). The relatively slow response of the PFC circuit worsens the impact of the AC inrush current.

However, using a system as described herein, the PFC circuit response can be sped up to less than half AC line frequency cycle (e.g., less than five milliseconds) and AC inrush current on dynamic load condition can be stabilized smoothly. The approaches described herein may also be used to improve AC sag/dropout performance of a digital power supply.

Conventional PFC circuits rely on the voltage of a bulk capacitor (Vbus) within the PFC circuit to detect a dynamic load condition. As a result, the conventional PFC circuits cannot detect a dynamic load event fast enough and the drop in bulk capacitor voltage results in an overshoot. To remedy this situation, conventional PFC circuit designers often increase the size of the bulk capacitor at the PFC output.

As described herein, a PFC circuit may be enabled to respond faster to dynamic load conditions by receiving an accurate representation of the output current of the DC-DC converter (i.e., secondary side output current information) (Iout). Using the Iout information, the PFC circuit may be controlled more accurately and quickly in response to dynamic load conditions. Using the feedback secondary Iout information, the PFC circuit can be controlled in such a way as to limit AC input transient peak current of Power Supply

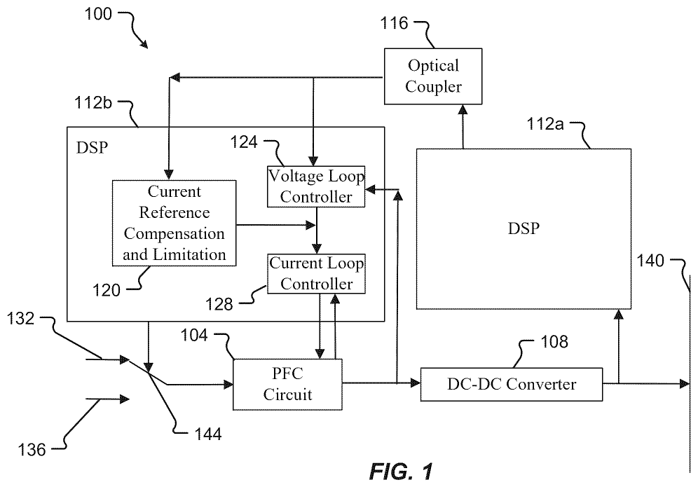

As illustrated in FIG. 1, a power supply device 100 may include a PFC circuit 104 controlled by a primary digital signal processor (DSP) 112b and a DC-DC converter 108. The PFC circuit 104 may receive power from a power source. In some implementations, a power source may be an AC power grid 132, an uninterruptible power supply (UPS) 136 or other source of power. In some implementations, the power received by the PFC circuit 104 may be selected between the AC power grid 132, UPS 136, and/or other sources. For example, a DSP 112b may be configured to operate a switch 144 to switch between two or more power sources. The power supply device 100 may output power to a load 140.

A PFC circuit 104 of the power supply device 100 may form the primary side of the power supply device 100. The PFC circuit 104 may receive power from the power source and may include a bulk capacitor which may store the received power. The bulk capacitor may be considered the middle stage of the power supply device. The bulk capacitor may serve as a buffer to preserve the energy from the power source.

The PFC circuit 104 may be controlled by a DSP 112b to adjust a phase difference between the voltage and current waveforms. The PFC circuit 104 may be an active PFC circuit. For example, the PFC circuit 104 may use components such as MOSFETs controlled by integrated circuits. The PFC circuit 104 may be controlled by a DSP 112b in such a way as to control a maximum input current and voltage based on data associated with the output current (Iout) of the DC-DC converter as described in greater detail below.

The PFC circuit 104 may be configured to respond to a dynamic event. A dynamic event as described herein may be a sharp increase or a sharp decrease in demand from the load. When a dynamic event occurs, an in-rush current from the power source may also occur.

An in-rush current as described herein may be an initial surge of electrical current into the power supply device 100 when a sharp increase in demand from the load occurs. When the increase in demand from the load occurs, the voltage across the bulk capacitor may reduce. The bulk capacitor may draw the in-rush current to recharge its voltage.

In conventional power supply devices, without communication from the output side of the DC-DC converter side to the PFC circuit, the only way the PFC circuit knows the dynamic event is occurring is the bulk capacitor voltage dropping. Because conventional PFC circuits rely on the bulk capacitor voltage to respond to dynamic events, conventional PFC circuits cannot react quickly enough to avoid negative effects of the in-rush current, such as a voltage overshoot. This is particularly an issue in modern data centers which perform computations. The power consumed by servers in such data centers may be required to quickly increase or decrease. However, by using the output current to detect dynamic events, a PFC circuit 104 can respond to dynamic events faster.

A secondary side of the power supply device 100 may include a DC-DC converter 108. The voltage from the bulk capacitor of the PFC circuit 104 may be output to the DC-DC converter 108. The DC-DC converter 108 may take the DC power from the bulk capacitor of the PFC circuit 104 and adjust an output of the DC-DC converter 108 to meet a demand from the load. In this way, the DC-DC converter 108 role is to maintain a stable and precise output voltage despite any variations in input power or load conditions.

The DC-DC converter 108 may be configured to use feedback mechanisms to detect an increased load demand as a potential drop in output voltage. The DC-DC converter 108 may respond by increasing its duty cycle or changing a switching frequency to boost the output power. In this way, the DC-DC converter 108 may ensure that the load receives a constant voltage supply even as its demand spikes.

When a spike in demand occurs, the DC-DC converter 108 may output an increased amount of current (Iout) to the load bus. As described herein, the Iout output by the DC-DC converter 108 to the load bus may be monitored using a DSP 112b.

As described herein, a DSP 112 may be configured to perform a number of functions including monitoring Iout from the DC-DC converter 108 and/or controlling the PFC circuit 104 to avoid or mitigate a drop in voltage across the bulk capacitor when a sharp increase (or a sharp decrease) in demand from the load occurs.

In some implementations, the power supply device 100 may include a primary DSP 112b and a secondary DSP 112a. The secondary DSP 112a may operate to measure the output current (Iout) of the DC-DC converter and to provide data representing the Iout to an optical coupler 116. The primary DSP 112b may operate as a controller of the PFC circuit 104 and may receive data representing the Iout from the optical coupler 116.

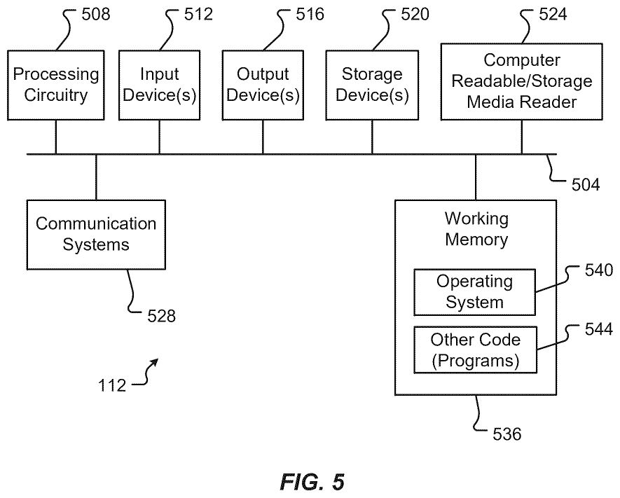

Each of the primary and secondary DSPs 112 may include hardware components as illustrated in FIG. 5 and described below. While the primary DSP 112b and the secondary DSP 112a are described as being separate components, it should be appreciated that the same or similar systems as described herein may be implemented using a single DSP 112 performing the functions of the primary DSP 112b and the secondary DSP 112a.

As referenced above, the secondary DSP 112a may be configured to read the current output by the DC-DC converter 108 (Iout). The Iout may be read as an analog signal in terms of amperage. The secondary DSP 112a may output the raw Iout signal or data created by processing the raw Iout signal to an optical coupler 116.

In some implementations, a current sensor may be used by the secondary DSP 112a to monitor Iout. Such a current sensor may be, for example, a Hall effect sensor which may be used to detect a magnetic field generated by the flow of current. Such a Hall effect sensor or other type of current sensor may produce a voltage that is proportional to the amount of current flowing through a conductor. This voltage can then be read by the secondary DSP 112a to monitor and analyze the current in real-time.

In some implementations, a shunt resistor placed in series with the DC-DC converter 108 may be used by the secondary DSP 112a to monitor the Iout. As current flows through the shunt resistor, a small voltage drop occurs across it, proportional to the current. This voltage drop may be continuously monitored by the secondary DSP 112a, which may calculate the actual current using the known resistance value of the shunt.

In addition to a current sensor, the secondary DSP 112a may employ one or more algorithms to further refine the current measurement. For example, the secondary DSP 112a may read current from a current sensor, process the current reading, determine a current or average current over time, such as a moving average over a specific period of time.

Optical couplers as described herein, which may also be referred to as optocouplers, may include any components capable of transmitting electrical signals between two circuits by using light waves. Such components may include a light emitter, such as a light-emitting diode (LED), and a light receiver, such as a phototransistor or photodiode. In response to an electrical signal applied to the LED, light proportional to the signal's intensity may be emitted. The light may be detected by the light receiver, which converts the light back into an electrical signal. This process may enable the secondary DSP 112a to remain electrically isolated from the DC-DC converter 108, protecting electronics from voltage spikes and surges.

In some implementations, the optical coupler may include a linear optical coupler which may utilize fiber optics to split or combine optical signals. In a linear optical coupler, light from one or more input fibers may be mixed and redistributed to one or more output fibers. As should be appreciated, in some implementations, other couplers, including non-optical couplers, may be used.

The optical coupler 116 may provide a fast way (e.g., less than one millisecond) to transfer the secondary side output current information (Iout) to the primary side.

The transfer of the Iout information may occur in one or more of a variety of manners. The optical coupler 116 or the secondary DSP 112a may be configured to represent the raw Iout data in terms of one or more of frequency or duty cycle, or a digital serial or linear analog signal.

In some implementations, Iout may be provided to the primary DSP 112b in the form of a frequency-based signal. The Iout value may be converted into a frequency, where a high Iout value is represented by a high frequency and a low Iout value is represented by a low frequency. As an example, zero amps may be represented by a frequency of one hundred kilohertz and a full load, or maximum Iout, may be represented as a frequency of two hundred kilohertz. Iout measurements between zero and one hundred percent of the maximum Iout may be represented by coordinated values between one hundred and two hundred kilohertz. For example, an Iout of fifty percent of the full load may be represented as a frequency of one hundred and fifty kilohertz. As should be appreciated, the exact values provided herein are provided for example purposes only and should not be considered as limiting in any way.

In some implementations, Iout may be provided to the primary DSP 112b in the form of a duty cycle-based signal. The Iout value may be converted into a duty cycle, where a high Iout value is represented by a high duty cycle and a low Iout value is represented by a low duty cycle. As an example, zero amps may be represented by a duty cycle of zero percent and a full load, or maximum Iout, may be represented by a duty cycle of one hundred percent. Iout measurements between zero and one hundred percent of the maximum Iout may be represented by duty cycles of coordinating values between zero and one hundred percent. For example, an Iout of fifty percent of the full load may be represented by a duty cycle of fifty percent. As should be appreciated, the exact values provided herein are provided for example purposes only and should not be considered as limiting in any way.

In some implementations, Iout may be provided to the primary DSP 112b in the form of a digital serial communication signal. As an example, the digital serial communication signal may include a series of bits which may be used to represent Iout values between zero amps and a maximum Iout.

In implementations utilizing a digital serial communication signal, the optical coupler 116 may be a high-speed optocoupler capable of supporting high baud rates (e.g., 115200 baud rates). As an example, Iout may be provided to the primary DSP 112b in the form of packets. Each packet may include a representation of the Iout as a payload of the packet.

In some implementations, Iout may be provided to the primary DSP 112b in the form of a linear analog signal. To provide Iout to the primary DSP 112b in the form of a linear analog signal, an optical coupler 116, such as a linear optocoupler, may be used. As an example, zero amps may be represented by an analog value of one volt and a full load, or maximum Iout, may be represented by an analog value of two volts. Iout measurements between zero and one hundred percent of the maximum Iout may be represented by voltages of coordinating values between one and two volts. For example, an Iout of fifty percent of the full load may be represented by a voltage of one and a half volts. As should be appreciated, the exact values provided herein are provided for example purposes only and should not be considered as limiting in any way.

Whether converted to a frequency, duty-cycle, digital signal, or not, the secondary DSP 112a may provide the data associated with the output current of the secondary side (Iout) to the primary DSP 112b via the optical coupler 116. As referenced above, the optical coupler 116 may not be necessary in some implementations. Also, in some implementations a single DSP 112 may perform the functions of both the primary and secondary DSPs 112b, 112a, and in such implementations, there may be no need for an optical coupler 116.

The primary DSP 112b of the power supply device 100 may be configured to operate as a PFC controller. The primary DSP 112b may utilize a voltage loop controller 124 and a current loop controller 128 to control the PFC circuit 104.

In some implementations, the primary DSP 112b may include one or more voltage loop controllers which may be used to control the PFC circuit 104. The voltage loop controller 124 may control the output voltage of the PFC circuit 104 such that the output remains stable and close to a desired setpoint regardless of any fluctuations in load or input voltage.

The voltage loop controller 124 may regulate the output voltage of the PFC circuit 104 by adjusting a duty cycle of the PFC circuit 104 based on feedback received about the output voltage of the DC-DC converter 108. This adjustment may be used to maintain a steady voltage supply even under varying load conditions and input voltages.

A voltage loop controller as described herein may include one or more of several components, such as an analog-to-digital converter (ADC), a DSP circuit, or another type of circuitry.

The voltage loop controller 124 may receive the Iout data via the optical coupler as well as a reference signal representing a voltage across the bulk capacitor of the PFC circuit 104 (Vbulk).

Using the Iout data and the Vbulk reference signal, the voltage loop controller 124 may be configured to generate data which may be used by the current loop controller 128 to control the PFC circuit 104. The data generated by the voltage loop controller 124 may be output by the voltage loop controller 124 to the current loop controller 128.

The primary DSP 112b may be configured to calculate a current reference compensation and limitation 120 which may be provided to the current loop controller 128 as a data signal.

In some implementations, the primary DSP 112b may perform current reference compensation and limitation calculations to control the PFC circuit 104. Current reference compensation may involve adjusting a reference current to align the reference current with an input voltage waveform. Current limitation may be used to ensure that the current drawn by the PFC circuit 104 does not exceed a predefined limit.

The current reference compensation and limitation calculations may be implemented as hardware circuits or software algorithms running on the DSP. Such algorithms may utilize real-time data from sensors and adjust control signals accordingly. The current reference compensation and limitation 120 may be calculated based on the Iout data received by the primary DSP 112b from the secondary DSP 112a via the optical coupler 116. After the current reference compensation and limitation 120 is calculated, the current reference compensation and limitation 120 may be output to the current loop controller 128 of the primary DSP 112b.

As described above, data from the current reference compensation and limitation 120 calculation and the voltage loop controller 124 may be received by the current loop controller 128. The current loop controller 128 may also be configured to receive current feedback information from the PFC circuit 104. Using the data received from the voltage loop controller 124, the calculated current reference compensation and limitation 120, and the PFC current feedback, the current loop controller 128 may be capable of controlling switches inside the PFC circuit 104 to control the performance of the PFC circuit 104.

In some implementations, the primary DSP 112b may utilize a current loop controller to control the PFC circuit 104 to maintain a current flow at a particular level and to enhance the efficiency of the PFC circuit 104. The current loop controller 128 may be used to regulate current through the PFC circuit 104 such that the current matches a desired reference current. The reference may in some implementations be shaped to mirror an AC input voltage waveform, ensuring that the current and voltage are in phase.

As described above, the secondary DSP 112a and the optical coupler 116 enable the primary DSP 112b to quickly receive secondary side output current (Iout) information. By quickly receiving the Iout information, the primary DSP 112b can control the PFC circuit 104 in such a way as to speed up the response time as compared to conventional PFC circuits by determining the output load and utilizing the output load determination to control the PFC voltage loop directly. In this way, the voltage on the bulk capacitor of the PFC circuit 104 can be maintained and will drop less when a sharp increase in demand occurs at the load 140, and the resultant AC inrush current caused by the load transient can be decreased as compared to conventional PFC circuits.

A PFC circuit 104 as described herein may utilize a voltage loop and a current loop for ensuring efficient and stable operation. The voltage and control loops may be used to manage the output voltage and input current of the PFC circuit 104. A voltage loop of the PFC circuit 104 may be responsible for regulating an output voltage of the PFC circuit 104 to a predetermined level, regardless of variations in load or input voltage. A current loop of the PFC circuit 104 may be designed to shape a current within the PFC circuit 104 such that the current aligns with the input AC voltage waveform.

Both the voltage and current loops within the PFC circuit 104 may operate in tandem. While the voltage loop ensures stable and consistent output voltage, the current loop optimizes the input side by improving the power factor. The voltage and current loops within the PFC circuit 104 may be controlled by the primary DSP 112b.

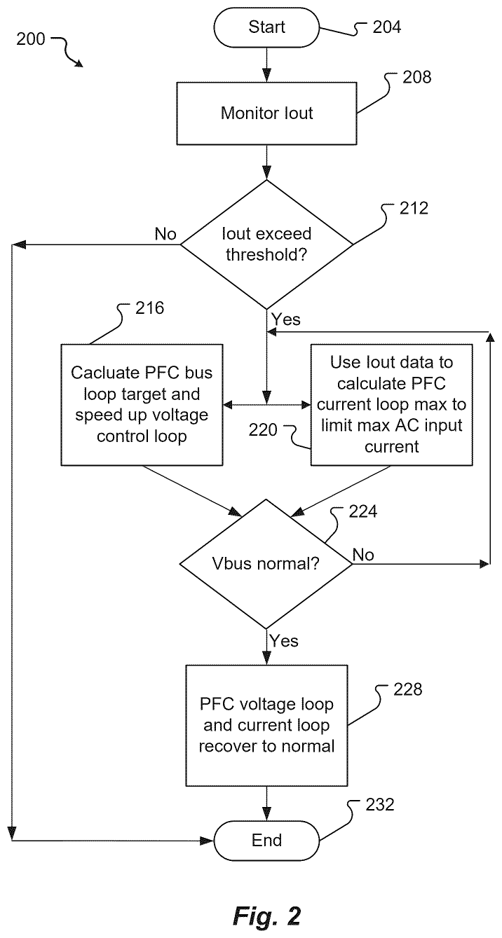

Through the systems and methods described herein, the PFC circuit 104 can be controlled to respond quickly to sharp increases or decreases in demand of the load 140. Because the PFC circuit 104 has a low response time, when the load increases, the DC-DC converter will be enabled to access energy from the bulk capacitor of the PFC circuit 104. When the PFC voltage starts to respond, the PFC circuit 104 can draw energy from the power source to not only supply the output load but also charge the bulk capacitor back to its normal setpoint. In this way, by getting the secondary side Iout information, the PFC circuit 104 can respond quick enough so as to reduce or eliminate any drop in voltage on the bulk capacitor and prevent or reduce AC inrush current caused by load transients. This can be achieved through the performance of a method 200 as illustrated in FIG. 2 and described below.

As illustrated in FIG. 2, a method 200 may be performed by one or more DSPs 112. While the method 200 is described as being performed by a primary DSP 112b and a secondary DSP 112a, it should be appreciated that in some implementations the method 200 may be performed by other processing circuitry including, for example, a single DSP or another type of processor.

The method 200 may begin at 204. The method 200 may operate at any time during the operation of a power supply device 100 such as illustrated in FIG. 1. The power supply device 100 may supply power from a power grid, a UPS, or any other type of power source to a load bus. The voltage on the load bus may be referred to as Vbus.

At 208, a DSP 112, such as a primary DSP 112b as described herein, may monitor an output current (Iout) of a DC-DC converter 108. The primary DSP 112b may monitor the output current (Iout) of the DC-DC converter 108 by receiving a signal from an optical coupler 116 as described above.

The signal received from the optical coupler 116 may be in the form of a frequency-based signal, a duty cycle-based signal, an analog signal, a digital serial communication signal, or other format.

The DSP 112 may be enabled to read the received signal and determine, at 212, whether the Iout exceeds a threshold. It should be appreciated that while the systems and methods described herein are described in relation to responding to a sharp increase in demand from the load 140, the same or similar methods may be implemented to enable a PFC circuit 104 to respond to a sharp decrease in demand from the load 140.

When the Iout exceeds the threshold, the DSP 112 may be configured to determine a dynamic event has occurred. In some implementations, the method 200 may pause or loop at 212 until a dynamic event occurs. In some implementations, the DSP 112 may control the PFC circuit 104 in response to the Iout regardless of whether a dynamic event occurs, and in other implementations, the method 200 may end at 232 or restart if a dynamic event does not occur.

If Iout exceeds the threshold, the DSP 112 may, at 216, calculate a PFC bus loop voltage target and speed up a voltage control loop of the PFC circuit 104 to reach the voltage target. The DSP 112 may also, at 220, use the Iout data to calculate a maximum current and control a PFC current loop of the PFC circuit 104 to limit the input current to the maximum current. In some implementations, the PFC current loop may be controlled by the DSP 112 in such a way as to track a sinusoidal waveform, in terms of amplitude and frequency, to meet the demands of the load 140.

At 224, a determination may be made as to whether the voltage of the bulk capacitor (Vbus) is normal. Determining whether the Vbus is normal may involve measuring the Vbus and comparing the measurement to one or more thresholds. In some implementations, if the Vbus is within a particular percentage of an ideal voltage the DSP 112 may determine the Vbus is normal.

If the DSP 112 determines the Vbus is not at a normal level, the calculations and controlling of the PFC circuit 104 at 216 and 220 may continue as necessary until Vbus is normal. In response to determining the Vbus has returned to normal, the DSP 112 may control the PFC voltage and current as normal at 228.

Once the PFC voltage loop and current loop recover to normal and are being controlled as normal at 228, the method 200 may end at 232.

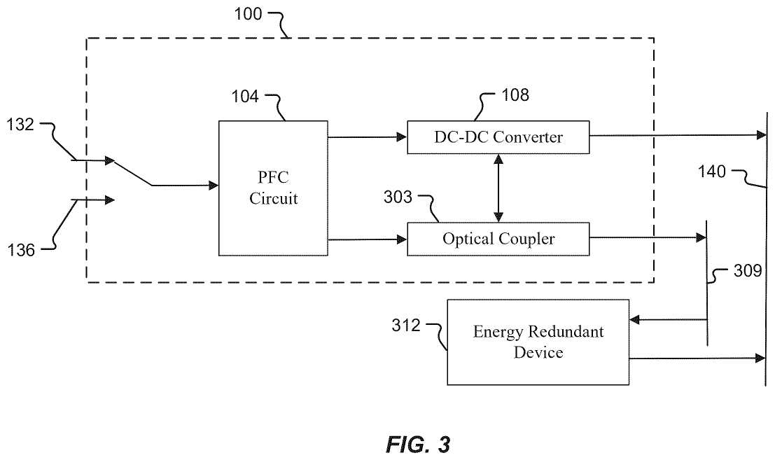

In some implementations, a power supply device 100 may operate in conjunction with one or more energy redundant devices 312 such as illustrated in FIG. 3. The power supply device 100 may receive power from one or more power sources such as a power grid 132 and/or a UPS 136. The power supply device 100 may include a PFC circuit 104 and a DC-DC converter 108 as described above. The power supply device may also include one or more optical couplers 303. The optical coupler 303 may be the same as or similar to the optical coupler 116 as described above. The DC-DC converter 108 may receive power from the PFC circuit 104 and output power to a load 140 as described above. The optical coupler 303 may be configured to output data to a bus 309.

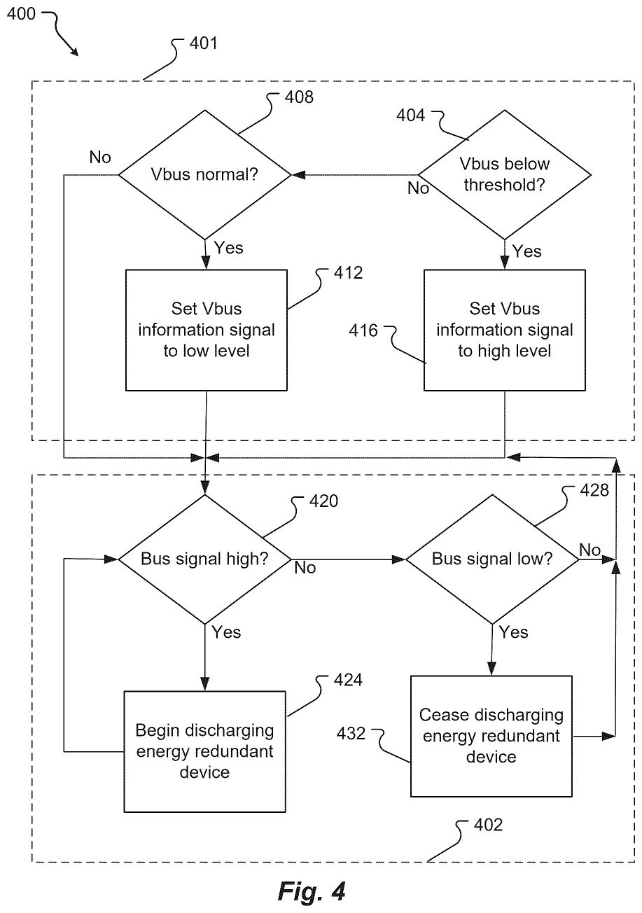

The energy redundant device 312 may be configured to read data from the bus 309 and to output power to the load 140 at selected times. The energy redundant device 312 may be controlled by one or more DSPs 112 such as described herein or another type of processing circuitry. The data output by the optical coupler 303 to the bus 309 may include data associated with a voltage of the bulk capacitor of the PFC circuit 104. The energy redundant device may be capable of reading the data from the bus 309, determining the voltage of the bulk capacitor of the PFC circuit 104 based on the data from the bus 309, and in response to the voltage of the bulk capacitor of the PFC circuit, discharge power to the load 140. The process of selectively discharging power from the energy redundant device 312 may be performed through a method 400 such as illustrated in FIG. 4 and described below.

The optical coupler 303 may be used for transferring bulk capacitor voltage (Vbus) information from the PFC circuit 104 to be read by the energy redundant device 312 using the bus 309 (Vbus_share_bus). The energy redundant device may provide power to the load 140 or cease providing power to the load 140 based at least in part on a value stored on the bus 309.

When an energy redundant device 312 is present along with a power supply device 100 as described herein, further smoothing of the AC current slope can be achieved by sending information representing the voltage of the bulk capacitor (Vbus) of the PFC circuit 104 as feedback to the energy redundant device. The energy redundant device can be utilized to provide power to the load 140 when the power supply device 100 struggles to meet the demands of the load 140 by providing output power to the load 140 based at least in part on the Vbus. With the energy redundant device sharing part of loading, the slope of the AC input can be controlled. In this way, the energy redundant device knows the bulk voltage information exactly and can adjust its loading level accordingly.

When the Vbus drops to a low level, such as in the event of an AC sag or drop out, an AC inrush current may occur. When the AC power recovers, the PFC circuit 104 may be required to provide energy to supply not only the load 140 but also to charge the bulk capacitor back to its normal setpoint. This may cause an AC inrush current higher than steady load condition. Furthermore, a droop on the Vbus may also occur.

To avoid the droop on the Vbus and/or the AC inrush current, an energy redundant device 312 may be configured to detect a drop in the Vbus and to respond by providing power to the load 140 using a method 400 as described below.

The method 400 may include two phases 401, 402. A phase 401 may be performed by a DSP 112 or other processing circuitry of the power supply device 100. Another phase 402 may be performed by a DSP 112 or other processing circuitry of an energy redundant device 312 such as illustrated in FIG. 3. A DSP 112 or other processing circuitry which is capable of performing the methods 200 and 400 may be as illustrated in FIG. 5 and as described in greater detail below. The method 400 may be performed simultaneously, such as in parallel, with the method 200 described above. Or in some implementations, only one of methods 200 and 400 may be performed.

A phase 401 may begin at 404 in which a determination is made as to whether the voltage at Vbus has dropped. Determining whether the voltage at Vbus has dropped may be implemented by comparing the Vbus voltage to a threshold level or by monitoring the Vbus voltage to detect a positive or negative change.

If the voltage at Vbus has not dropped, a determination may be made as to whether the output bus voltage is normal at 408. If the output bus voltage is normal, a bulk voltage information signal may be set to a low level and the method 400 may involve performing another phase 402 as described below. If the voltage at Vbus has dropped, the bulk voltage information signal may be set to a high level 416.

The steps of the phase 401 of the method 400 illustrated in FIG. 4 are provided for illustration purposes only and involve setting the bulk voltage information signal on the bus 309 to a high level or a low level. Setting the bulk voltage information signal on the bus 309 may involve providing a signal which can be detected by an energy redundant device. As described below in relation to another phase 402, the energy redundant device may be enabled to respond to the signal on the bus 309 by either beginning or ceasing the discharging of energy to supplement power delivered by the power supply device 100 to a load.

The setting of the bulk voltage information signal may be implemented in any one or more of a variety of ways. Such ways include, for example, providing a representation of the output bus voltage in the form of a frequency signal. For example, the output bus voltage may be represented by a signal at a particular frequency, a signal at a particular a duty cycle, a digital signal at a particular voltage and/or amperage, a linear analog signal at a particular voltage and/or amperage, or otherwise. In some implementations, the bulk voltage information signal may be set as a simple on/off signal. For example, if the bulk cap voltage is below a threshold, a one or relatively high voltage or amperage may be output to alert the energy redundant device. Once the bulk cap voltage is above the threshold, the signal may be switched to zero, off, or a relatively low voltage or amperage.

In some implementations, instead of performing the phase 401, the optical coupler may simply output a representation of the Vbus to the bus 309 to be read by the energy redundant device 312.

Another phase 402 may begin at 420 in which a determination may be made as to whether a signal on the bus 309 is high. The determination as to whether the signal on the bus 309 is high may be made by the energy redundant device 312, or a controller thereof. To determine whether the signal on the bus 309 is high, the energy redundant device 312 may be configured to read the value of the signal on the bus 309 and to determine, based on the value of the signal on the bus 309, whether the output bus voltage is high or is at an adequate value. As an example, a high value may be equivalent to a one or a maximum voltage on the bus 309, whereas a low value may be equivalent to a zero or a minimum voltage on the bus 309.

If the value of the signal on the bus 309 is high, representing that the energy redundant device 312 should begin discharging, such as in the event that the output bus voltage is low, the energy redundant device 312 may begin discharging at 424 to supplement the power delivered by the power supply device 100 to the load. After beginning discharging, the phase 402 of the method 400 may return to 420 and another determination may be made as to whether the signal on the bus 309 is high.

If the signal on the bus 309 is not high, the energy redundant device 312 may, at 428, determine whether the signal on the bus 309 is low, representing that the energy redundant device 312 should cease discharging, such as in the event that the power supply device 100 is providing an adequate amount of power to the load.

If the value of the signal on the bus 309 is low, representing that the power supply device 100 is providing an adequate amount of power to the load, the energy redundant device 312 may cease discharging at 432. After ceasing discharging, the phase 402 of the method 400 may return to 420 and another determination may be made as to whether the signal on the bus 309 is high.

If the value of the signal on the bus 309 is neither high nor low, the phase 402 of the method 400 may involve the energy redundant device 312 continuing to monitor the signal on the bus at 420 as described above and another determination may be made as to whether the signal on the bus 309 is high.

FIG. 5 is a block diagram illustrating elements of an exemplary DSP 112 in which embodiments of the present disclosure may be implemented. More specifically, this example illustrates one embodiment of a DSP 112 upon which the systems, controllers, and/or components described herein may be deployed or executed. The DSP 112 is shown comprising hardware elements that may be electrically coupled via a bus 504. The hardware elements may include one or more processing circuitry 508; one or more input devices 512 (e.g., a mouse, a keyboard, etc.); and one or more output devices 516 (e.g., a display device, a printer, etc.). The DSP 112 may also include one or more storage devices 520. By way of example, storage device(s) 520 may be disk drives, optical storage devices, solid-state storage devices such as a Random-Access Memory (RAM) and/or a Read-Only Memory (ROM), which can be programmable, flash-updateable and/or the like.

The DSP 112 may additionally include a computer-readable storage media reader 524; a communications system 528 (e.g., a modem, a network card (wireless or wired), an infra-red communication device, etc.); and working memory 536, which may include RAM and ROM devices as described above.

The computer-readable storage media reader 524 can further be connected to a computer-readable storage medium, together (and, optionally, in combination with storage device(s) 520) comprehensively representing remote, local, fixed, and/or removable storage devices plus storage media for temporarily and/or more permanently containing computer-readable information. The communications system 528 may permit data to be exchanged with a network and/or any other computer described above with respect to the computer environments described herein. Moreover, as disclosed herein, the term “storage medium” may represent one or more devices for storing data, including ROM, RAM, magnetic RAM, core memory, magnetic disk storage mediums, optical storage mediums, flash memory devices and/or other machine-readable mediums for storing information.

The DSP 112 may also comprise software elements, shown as being currently located within a working memory 536, including an operating system 540 and/or other code 544. It should be appreciated that alternate embodiments of a DSP 112 may have numerous variations from that described above. For example, customized hardware might also be used and/or particular elements might be implemented in hardware, software (including portable software, such as applets), or both. Further, connection to other computing devices such as network input/output devices may be employed.

Examples of the processing circuitry 508 as described herein may include, but are not limited to, an FPGA, an ASIC, and/or a CPU, such as at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In view of the foregoing description, it should be appreciated that example embodiments provide methods and devices for providing steady power during high load events.

At least one example embodiment is directed to a power supply device. The power supply device includes a power factor correction circuit; a DC-DC converter; and one or more controller circuits configured to: monitor an output current of the DC-DC converter; detect, based on the output current of the DC-DC converter, one of a drop and an increase in the output current; and control the power factor correction circuit in response to the one of the drop and the increase in the output current.

According to at least one example embodiment, the one or more controller circuits include a first digital signal processor (DSP) and a second DSP, wherein the first DSP controls the power factor correction circuit, and the second DSP monitors the output current of the DC-DC converter.

According to at least one example embodiment, the second DSP outputs a signal associated with the output current of the DC-DC converter to an optical coupler.

According to at least one example embodiment, the optical coupler converts the signal associated with the output current of the DC-DC converter to one of a frequency-based signal, a duty-cycle-based signal, digital serial communication, and a linear analog signal.

According to at least one example embodiment, the power supply device further comprises an energy redundant device, wherein the energy redundant device is configured to read a measurement of a voltage of the power factor correction circuit.

According to at least one example embodiment, the energy redundant device is further configured to begin discharging in response to the measurement of the voltage of the power factor correction circuit.

According to at least one example embodiment, the energy redundant device is configured to read the measurement of the voltage of the power factor correction circuit by receiving a signal from an optical coupler.

According to at least one example embodiment, the optical coupler is configured to receive an indication of the voltage of the power factor correction circuit and to output a digital signal in response to the indication of the voltage of the power factor correction circuit.

At least one example embodiment is directed to a power factor correction controller. The power factor correction controller includes one or more circuits to: monitor an output current of a DC-DC converter; detect, based on the output current of the DC-DC converter, one of a drop and an increase in the output current; and control a power factor correction circuit in response to the one of the drop and the increase in the output current.

According to at least one example embodiment, the one or more circuits include a first digital signal processor (DSP) and a second DSP, wherein the first DSP controls the power factor correction circuit, and the second DSP monitors the output current of the DC-DC converter.

According to at least one example embodiment, the second DSP outputs a signal associated with the output current of the DC-DC converter to an optical coupler.

According to at least one example embodiment, the optical coupler converts the signal associated with the output current of the DC-DC converter to one of a frequency-based signal, a duty-cycle-based signal, digital serial communication, and a linear analog signal.

According to at least one example embodiment, an energy redundant device is configured to read a measurement of a voltage of the power factor correction circuit.

According to at least one example embodiment, the energy redundant device is further configured to begin discharging in response to the measurement of the voltage of the power factor correction circuit.

According to at least one example embodiment, the energy redundant device is configured to read the measurement of the voltage of the power factor correction circuit by receiving a signal from an optical coupler.

According to at least one example embodiment, the optical coupler is configured to receive an indication of the voltage of the power factor correction circuit and to output a digital signal in response to the indication of the voltage of the power factor correction circuit.

At least one example embodiment is directed to a method of providing power factor correction for a power supply, the method includes: monitoring an output current of a DC-DC converter; detecting, based on the output current of the DC-DC converter, one of a drop and an increase in the output current; and controlling a power factor correction circuit in response to the one of the drop and the increase in the output current.

According to at least one example embodiment, the one or more circuits include a first digital signal processor (DSP) and a second DSP, wherein the first DSP controls the power factor correction circuit, and the second DSP monitors the output current of the DC-DC converter.

According to at least one example embodiment, the second DSP outputs a signal associated with the output current of the DC-DC converter to an optical coupler.

According to at least one example embodiment, the optical coupler converts the signal associated with the output current of the DC-DC converter to one of a frequency-based signal, a duty-cycle-based signal, digital serial communication, and a linear analog signal.

Any one or more of the aspects/embodiments as substantially disclosed herein.

Any one or more of the aspects/embodiments as substantially disclosed herein optionally in combination with any one or more other aspects/embodiments as substantially disclosed herein.

One or more means adapted to perform any one or more of the above aspects/embodiments as substantially disclosed herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

The terms “determine,” “calculate,” “compute,” and variations thereof, as used herein, are used interchangeably, and include any type of methodology, process, mathematical operation, or technique.

What is claimed is:

1. A power supply device, comprising:
a power factor correction circuit;
a DC-DC converter; and
one or more controller circuits configured to:
monitor an output current of the DC-DC converter;
detect, based on the output current of the DC-DC converter, one of a drop and an increase in the output current; and
control the power factor correction circuit in response to the one of the drop and the increase in the output current.

2. The power supply device of claim 1, wherein the one or more controller circuits include a first digital signal processor (DSP) and a second DSP, wherein the first DSP controls the power factor correction circuit and the second DSP monitors the output current of the DC-DC converter.

3. The power supply device of claim 2, wherein the second DSP outputs a signal associated with the output current of the DC-DC converter to an optical coupler.

4. The power supply device of claim 3, wherein the optical coupler converts the signal associated with the output current of the DC-DC converter to one of a frequency-based signal, a duty-cycle-based signal, digital serial communication, and a linear analog signal.

5. The power supply device of claim 1, wherein the power supply device further comprises an energy redundant device, wherein the energy redundant device is configured to read a measurement of a voltage of the power factor correction circuit.

6. The power supply device of claim 5, wherein the energy redundant device is further configured to begin discharging in response to the measurement of the voltage of the power factor correction circuit.

7. The power supply device of claim 5, wherein the energy redundant device is configured to read the measurement of the voltage of the power factor correction circuit by receiving a signal from an optical coupler.

8. The power supply device of claim 7, wherein the optical coupler is configured to receive an indication of the voltage of the power factor correction circuit and to output a digital signal in response to the indication of the voltage of the power factor correction circuit.

9. A power factor correction controller comprising one or more circuits to:
monitor an output current of a DC-DC converter;
detect, based on the output current of the DC-DC converter, one of a drop and an increase in the output current; and
control a power factor correction circuit in response to the one of the drop and the increase in the output current.

10. The power factor correction controller of claim 9, wherein the one or more circuits include a first digital signal processor (DSP) and a second DSP, wherein the first DSP controls the power factor correction circuit and the second DSP monitors the output current of the DC-DC converter.

11. The power factor correction controller of claim 10, wherein the second DSP outputs a signal associated with the output current of the DC-DC converter to an optical coupler.

12. The power factor correction controller of claim 11, wherein the optical coupler converts the signal associated with the output current of the DC-DC converter to one of a frequency-based signal, a duty-cycle-based signal, digital serial communication, and a linear analog signal.

13. The power factor correction controller of claim 9, wherein an energy redundant device is configured to read a measurement of a voltage of the power factor correction circuit.

14. The power factor correction controller of claim 13, wherein the energy redundant device is further configured to begin discharging in response to the measurement of the voltage of the power factor correction circuit.

15. The power factor correction controller of claim 13, wherein the energy redundant device is configured to read the measurement of the voltage of the power factor correction circuit by receiving a signal from an optical coupler.

16. The power factor correction controller of claim 15, wherein the optical coupler is configured to receive an indication of the voltage of the power factor correction circuit and to output a digital signal in response to the indication of the voltage of the power factor correction circuit.

17. A method of providing power factor correction for a power supply, the method comprising:
monitoring an output current of a DC-DC converter;
detecting, based on the output current of the DC-DC converter, one of a drop and an increase in the output current; and
controlling a power factor correction circuit in response to the one of the drop and the increase in the output current.

18. The method of claim 17, wherein the one or more circuits include a first digital signal processor (DSP) and a second DSP, wherein the first DSP controls the power factor correction circuit and the second DSP monitors the output current of the DC-DC converter.

19. The method of claim 18, wherein the second DSP outputs a signal associated with the output current of the DC-DC converter to an optical coupler.

20. The method of claim 19, wherein the optical coupler converts the signal associated with the output current of the DC-DC converter to one of a frequency-based signal, a duty-cycle-based signal, digital serial communication, and a linear analog signal.
